(19) United States
(12) Patent Application Publication
(10) Pub. No.: US 2015/0191336 A1
(43) Pub. Date: Jul. 9, 2015

(54) CORKSCREW

(71) Applicant: Julian BROWN, London (GB)

(72) Inventor: Julian Brown, London (GB)

(21) Appl. No.: 14/416,050

(22) PCT Filed: May 21, 2013
(86) PCT No.: PCT/GB2013/051328

§ 371 Date: Jan. 20, 2015

(30) Foreign Application Priority Data
Jul. 20, 2012 (GB) 1212966.4

(51) Int. Cl. B67B 7/04

(52) U.S. Cl. CPC B67B 7/0441

(57) ABSTRACT

A corkscrew (300, 600, 800, 900, 1000) comprising a threaded bit (124) for engaging a stopper (60), a shaft (318, 1018, 1118) supporting the threaded bit (318, 1018, 1118), and one or more lever arms (328, 628, 828, 928, 1028) connected to the shaft (318, 1018, 1118) by a rack-and-pinion arrangement (334, 330, 634, 630, 834, 830, 934, 930, 1034, 1030), the rack-and-pinion arrangement comprising one or more pinions (330, 630, 830, 930, 1030, 1034) operably connected to respective lever arms (328, 628, 828, 928, 1028) and a threaded rack (334, 634, 834, 934, 1034) comprising a thread (336, 636, 836, 936, 1036) extending around the shaft (318, 1018, 1118), wherein the threaded rack (334, 634, 834, 934, 1034) is of opposite handedness to the threaded bit (330, 630, 830, 930, 1030).

The invention relates to a device for removing a stopper from a container, and in particular a corkscrew.

### BACKGROUND

One design for a corkscrew 100 is shown in FIGS. 1(a) and 1(b), and is described in U.S. Pat. No. 1,753,026. The frame 102 has a locating ring 104, often with an insert of softer material, designed to sit on the neck of a bottle 50, connected by two struts 106 (or in some variants a tube) to a crossbar 108 which has a central cylindrical barrel 110 and vertical slots 112 in each end, and often a collar stop 114 designed to limit the depth that the corkscrew tip 116 can reach in the cork 60. The central shaft 118 connects a handle 120, often designed with an integral crown seal opener 122, to a corkscrew bit 124, and has a rack 134 disposed between the handle 120 and the corkscrew bit 124. The rack 134 comprises a number of annular ribs 126 formed around the shaft 118. The shaft 118 is driven axially by the operation of two lever arms 128, which rotate pinions 130 at their ends around axles 132. The axles 132 hold the lever arms 128 in the slots 112. The ribbed rack 134 and the pinions 130 form a rack-and-pinion arrangement. Note that throughout this description it is assumed, for clarity, that the corkscrew axis is vertical, with the handle upwards and the tip downwards, and that the thread of the corkscrew bit is right-handed.

In operation, the corkscrew bit 124 is screwed into the cork 60 or stopper by rotating the handle 120 clockwise with downward pressure, which process raises the lever arms 128 by actuating the rack and pinion. Pulling the lever arms 128 downwards draws the cork 60 upwards, allowing it to be extracted from the bottle 50.

The corkscrew 100 is designed so that the tip 116 of the corkscrew bit 124 is stopped short of the lower end 62 of a standard-sized cork 60. The locating ring 104 allows the corkscrew tip 116 to be aligned with the centre of the cork 60. When the lever arms 128 are fully down, the tip 116 of the corkscrew bit 124 should extend below the ring 104 and thus the tip 116 of the bit 124 should begin to penetrate the top 64 of the cork 60 when the ring 104 is initially placed firmly down on the neck of the bottle 50.

This design does have one significant drawback. The travel of the shaft 118 as the bit 124 is screwed into the cork 60 is limited to the distance between the position of the tip 116 with the lever arms 128 fully down (generally some distance into the cork 60) and the point where the tip 116 finishes, usually, and desirably, some way short of the lower end 62 of the cork 60. Since the travel of the cork 60 out of the neck of the bottle 50 is the same distance, some proportion of the cork 60 necessarily remains in the neck of the bottle 50 when the lever arms 128 are lowered to extract the cork 60. This proportion can be as much as one third.

The user has two choices for dealing with this problem. One is simply to pull the cork 60 out the rest of the way, which can require considerable force and entails some risk of breaking the cork 60, spilling the contents, or even breaking the bottle 50. The other is to screw the tip 116 of the bit 124 through the lower end 62 of the cork 60, with attendant risk of dislodging fragments into the contents, in order to re-raise the lever arms 128 partially, and then pull the lever arms 128 down a second time.

Patents have been sought or granted for certain adaptations of the design whose purpose is to provide for greater travel without screwing the corkscrew bit farther into the cork. In particular, Hardie (GB 2 365 855) has added a threaded spacer to the ring to allow some re-raising of the lever arms. Kainz (EP 2 174 905) has designed a mechanism for disengaging, raising and re-engaging the lever arm pinions. Love (WO 03/031312) has designed a lever arm assembly which, like that of Kainz, allows disengagement, adjustment and re-engagement of the lever arms. Delavis (FR 2 629 441) has designed a spacer which can be inserted between the ring and the bottle neck which allows a second operation of the lever arms.

FIG. 2 shows a further design for a corkscrew 200. The corkscrew 200 is altered from the design shown in FIG. 1 mainly by increasing the length of the rack 234 and the circumference of the pinions 230 in order to provide for an upward travel of the corkscrew bit 124 which is long enough to remove the cork 60 completely from the bottle 50 in one downward movement of the lever arms 228. Since the travel of the bit 124 is now equal to or longer than the length of the cork 60, the bit 124 necessarily starts from a position which is raised above the top 64 of the cork 60 in order to prevent the tip 116 from piercing the lower end 62 of the cork 60 at the extent of its downward travel. To initiate the screwing of the tip 116 into the cork 60, the lever arms 228 must be partially raised while the frame 202 is held down on the bottle 50 with one hand and the handle 120 is used to push the tip 116 down into the top 64 of the cork 60 with the other hand. This process of centering the tip 116 and initiating the engagement of the bit 124 in the cork 60 is appreciably more awkward than it is for the version in FIG. 1.

The listing or discussion of a prior-published document in this specification should not necessarily be taken as an acknowledgement that the document is part of the common general knowledge.

### SUMMARY

In a first aspect, the invention provides a corkscrew comprising a threaded bit for engaging a stopper, a shaft supporting the threaded bit, and one or more lever arms connected to the shaft by a rack-and-pinion arrangement, the rack-and-pinion arrangement comprising one or more pinions operably connected to respective lever arms and a threaded rack comprising a thread extending around the shaft, wherein the threaded rack is of opposite handedness to the threaded bit.

The threaded rack provides a corkscrew in which, in use, the bit travels farther for each degree of rotation of the lever arms during a removal operation than it does during a setting operation (where the setting operation is defined as the act of screwing the bit into the stopper, thereby raising the lever arms into a set position, and where the removal operation is defined as the act of depressing the lever arms from the set position so as to remove the stopper from the bottle).

In particular, the corkscrew may be designed to provide a length of travel which prevents the bit from passing through the lowermost end of the stopper during the setting operation, even when the bit starts its downward travel from the top of the stopper or from just inside the stopper, whilst allowing for a complete removal of the stopper from the bottle in one movement of the, or each, lever arm during the removal operation (“one-shot removal”).

In other words, providing the corkscrew with a threaded rack of opposite handedness to the threaded bit allows the threaded rack to amplify the movement of the lever arm or arms such that they reach their set position (which may exist at one extent of their range of motion) during the setting operation sooner than they would do with the ribbed rack 134 of FIG. 1. This shortens the travel of the bit during the setting operation compared to the removal operation (or rather provides for additional travel during the removal operation, compared to the setting operation), allowing for a one-shot removal whilst preventing the bit from passing through the lowermost end of the stopper during the setting operation, even when the bit starts its downward travel from the top of the stopper or from just inside the stopper.

The invention may achieve both easy centering of the bit and one-shot removal simply and simultaneously, with the added, considerable, advantage that the position of the lever arm or arms can be adjusted by simply spinning the frame, without any change in the position of the bit in the stopper. This is useful if the stopper is abnormally long or the user has not driven the bit in far enough. All of this is feasible without adding to the number of parts of the device, or appreciably complicating its manufacture.

Thus, there may be provided a device for removing a stopper from a container. In the invention as claimed, the device is a corkscrew. In one example, the corkscrew is a wing corkscrew. The term “wing corkscrew” is used in accordance with its standard meaning in the art, although it is intended to encompass corkscrews having one lever arm or more than two lever arms, in addition to the dual lever arm type. This type of corkscrew may alternatively be called an angel corkscrew or a butterfly corkscrew.

The container may be a bottle, for example a wine bottle. The stopper may be a bottle stopper, such as a cork or bung, and it may be made of natural or synthetic material.

The corkscrew may comprise a stopper-engaging element configured to be releasably attached to the stopper, to allow the corkscrew to engage and remove the stopper. In the invention as claimed, the stopper-engaging element is a threaded bit.

By “threaded bit” is meant a stopper-engaging element which comprises a helical or helicoidal element, such as a screw, worm or auger, which is rotated into the stopper so as to engage the stopper. As used herein, the terms “helical” or “helicoidal” are intended to encompass imperfect, modified, interrupted or tapered helices, and single or multiple helices. Thus, any helix may have a fixed or variable lead angle, and the bit may comprise a single, double or other multiple helix, otherwise termed a one-start, two-start or multiple start thread.

By “lever arm” is meant a substantially rigid or part-rigid element which is fixedly or removably attached to its pinion and which is sufficiently elongate to provide a mechanical advantage during the removal of the stopper.

The corkscrew may comprise a frame, which may be any structure configured to engage the bottle and to hold the pinion of the, or each, lever arm in engagement with the threaded rod. The frame may comprise a locating ring configured to align the axis of the bit with the centre of the stopper, that is, to centre the bit. The frame may comprise a foil cutter. The frame may serve to accommodate the stopper and may comprise a tube or any number of struts. The frame is further configured to maintain a gap between the locating ring and the axis of the pinions.

By “rack and pinion” is meant a linear actuator for converting rotational motion into linear motion, comprising a circular or part-circular gear called a pinion which is configured to engage teeth on a linear gear bar called a rack. Rotational motion applied to the pinion causes the rack to move, thereby translating the rotational motion of the pinion into the linear motion of the rack. The term “rack” is intended to cover the threaded rack, in which the thread serves as teeth to enable it to function as a rack, or linear gear bar, and also to cover the worm of a worm drive. Similarly, the term “pinion” is intended to cover the worm gear or helical gear of a worm drive.

By “threaded rack” is meant a part of a rod or shaft having a helical or helicoidal thread wound around it, or extending along its exterior surface. The rack may comprise a single-start or multiple-start thread. As with the threaded bit, the terms “helical” or “helicoidal” are intended to encompass imperfect, modified, interrupted or tapered helices, and single or multiple helices, such that the helix of the helical or helicoidal thread may have a fixed or variable lead angle. The lead angle may locally be zero, or negative, that is to say, opposite to the overall handedness of the thread. The rack may comprise a single, double or other multiple helical thread, otherwise termed a one-start, two-start or other multiple-start worm.

The shaft may comprise a handle to allow the user to push and/or rotate the bit into the stopper.

By “handedness” is meant the chirality of the thread, of either the threaded bit or threaded rack. Thus, “opposite handedness” refers to one of the threaded bit and threaded rack having a right-handed thread, and the other having a left-handed thread.

The term “travel” as used herein denotes the magnitude of the distance through which the bit (and thereby the engaged stopper) moves, in use, relative to the frame during the setting operation or during the removal operation. In particular, the term may be used in relation to the movement of the lever arms between fixed points in each operation, for example a first position and second position or a set position and finished position.

The corkscrew may comprise a plurality of lever arms. In this case, it is optional, both to maintain a generally symmetrical appearance and for convenience of operation, for the lever arms to be at the same degree of rotation relative to the axis of the threaded rack, and for the lever arms to rest against or near the frame when the lever arms are fully lowered.

The corkscrew may comprise a plurality of lever arms which have an identical shape to one another.

By configuring the lever arms to be identical to one another, the manufacture of the corkscrew may be simplified, thereby reducing costs.

To account for the rack being a threaded rack, in which the axial position of the thread may vary between diametrically opposite sides, the invention provides several arrangements for ensuring that the teeth of the pinions fully engage the thread, in the case that the corkscrew comprises a plurality of lever arms, and when each lever arm is at the same degree of rotation relative to the threaded rack.

In a first example, in which the corkscrew supports each pinion at the same axial position as the other pinions relative to an axis of the threaded rack, the teeth of each pinion are arranged to follow the thread by being circumferentially staggered relative to those of the other pinions.

By “circumferentially staggered” is meant that the positions of the teeth on the circumference of one pinion are rotated about the axis of the pinion relative to the positions of the teeth on other pinions.

By “follow the thread” is meant that the teeth of each pinion are fully engaged or meshed with the thread of the threaded rod, despite the fact that the pinions are circumferentially spread around the rod, with the thread following a helical or near-helical path.

In a second example, in which the teeth of each pinion are at the same circumferential positions as those of the other pinions, the teeth of each pinion are arranged to follow the thread by the corkscrew supporting the pinions at staggered axial positions relative to an axis of the threaded rack.

By “axial position” is meant a position along a line coincident with or parallel to the axis of the threaded rod.

In a third example, in which the corkscrew supports each pinion at the same axial position as the other pinions relative to an axis of the threaded rack, and in which the teeth of each pinion are at the same circumferential positions as those of the other pinions, the teeth of each pinion are arranged to follow the thread by spacing the teeth on each pinion by a number of degrees equal to or about 360/n, where n is an odd number greater than one.

Thus, two identical lever arms may be positioned on diametrically opposite sides of the threaded rack, both facing in the same direction, with the arrangement of teeth being such that both pinions fully engage the thread.

In a fourth example, in which the corkscrew supports each pinion at the same axial position as the other pinions relative to an axis of the threaded rack, and in which the teeth of each pinion are at the same circumferential positions as those of the other pinions, the teeth of each pinion are arranged to follow the thread by providing the threaded rack with a multiple-start thread, and positioning pinions around an axis of the threaded rack at angular intervals that are integer multiples of 360/m degrees, where m is the number of starts of the thread. In this way, each lever arm may be identical and inwardly facing, whilst fully engaging the thread.

The pinion teeth may comprise bearing faces which are angled relative to an axis of the pinion so as to be aligned with bearing faces of the threaded rack. In other words, each pinion may be a worm gear or helical gear. Alternatively, the pinion teeth may comprise bearing faces, part or parts of which are angled relative to an axis of the pinion so as to be aligned with bearing faces of the threaded rack. Additionally or alternatively, the pinion teeth may be throated.

In another aspect, the invention may provide a corkscrew of the dual lever arm type (a wing corkscrew), with a shaft having a thread of opposite handedness to the corkscrew bit. In one example, the corkscrew may have a left-handed helically-threaded shaft and a right-handed corkscrew bit. In another example, the corkscrew may have a right-handed helically-threaded shaft and a left-handed corkscrew bit.

The corkscrew may have two dissimilar lever arms diametrically opposite one another with respect to the shaft, whose pinion gear teeth are set at a relative displacement of half of one tooth separation.

The corkscrew may have identical lever arms, for simplicity of manufacture.

The corkscrew may have a single helical shaft thread, otherwise described as a one-start worm, identical lever arm pinions which are displaced relative to each other by one half of the pitch of the shaft thread along in the direction of the shaft axis, and whose lever arms are mounted such that the position of one lever arm is rotated around the axis of the shaft and displaced axially relative to the other lever arm by one half of the pitch of the shaft thread.

The corkscrew may have a single helical shaft thread, otherwise described as a one-start worm, identical lever arm pinions which are not relatively displaced from one another in the direction of the shaft axis (in other words, lever arm pinions which are equidistant from the plane of the locating ring), and lever arms which are mounted diametrically opposite one another, whose gear teeth are spaced such that a full circumference of the cog would have an odd number of equally spaced teeth, causing a tooth to be diametrically opposite a gap. Thus, two identical lever arms may be positioned on diametrically opposite sides of the threaded rack, both facing in the same direction, with the arrangement of teeth being such that both pinions fully engage the thread.

The corkscrew may have a double helical shaft thread, otherwise described as a two-start worm, identical lever arm pinions which are not relatively displaced from one another in the direction of the shaft axis (in other words, lever arm pinions which are equidistant from the plane of the locating ring), and lever arms which are mounted diametrically opposite each other with respect to the shaft.

The corkscrew may have lever arm pinion tooth faces all, part or parts of which are angled relative to the axis of the axle upon which the lever arm is mounted, so as better to align the gear's bearing faces with the bearing faces of the shaft thread. Additionally or alternatively, the gear teeth may be throated.

The corkscrew may have a threaded shaft that is shaped so as to have a die-extractable surface by avoiding undercuts, to facilitate its manufacture by die-casting.

The term “undercut” is used in its customary sense in the context of die-casting using a two-part mould with a planar parting surface. By “undercut” is meant a surface or empty volume that is on the viewer's side of the die-parting plane and is eclipsed by a closer surface of the solid, looking towards the die-parting plane along a line perpendicular to it.

The term “die-extractable surface” as used herein denotes the surface of a cast part shaped without any undercuts that would prevent the ready extraction of the cast part from the die.

The expression “avoid undercuts” as used herein means avoid any undercut that would prevent the ready extraction of the cast part from a straight-pull two-part die with a planar parting surface.

For application to the corkscrew of the invention, it is feasible to produce a serviceable threaded shaft whilst avoiding undercuts by choosing a suitable tapered ridge profile and by varying the lead angle of the thread. By “ridge profile” is meant a section through a ridge of the thread made by a plane that includes the axis of the shaft. By “tapered” is meant narrowing monotonically from root to tip, from both sides.

By way of example, the shaft thread may have a tapered ridge profile and may comprise regions of zero lead angle on opposite sides of the shaft, traversing a die-parting plane that includes the axis of the shaft, in order to provide a modified helical thread without undercuts.

The corkscrew may have lever arms that are shaped so as to have a die-extractable surface by avoiding undercuts, to facilitate their manufacture by die-casting.

Pinion tooth faces may be angled to be aligned with the bearing surfaces of the threaded rack, but fully angled (or helical) pinions cannot be designed without undercuts. However, by way of example, one face of each pinion tooth may be angled (to form an obtuse edge at the pinion face) on one side of the intended die-parting plane (generally, but not necessarily, the mid-plane of the pinion, perpendicular to its axis) and the other face of the tooth angled similarly on the opposite side of the die-parting plane to create a partially angled tooth, providing improved alignment with the bearing faces of the threaded rack, with no undercuts. Alternatively, each face may be angled on both sides of the pinion mid-plane, to create a lever arm pinion that has mirror symmetry across its mid plane, and is thus suitable for use in embodiments of the invention in which two identical lever arms face in the same direction.

The present invention includes one or more aspects, embodiments or features in isolation or in various combinations whether or not specifically stated (including claimed) in that combination or in isolation.

The above summary is intended to be merely exemplary and non-limiting.

### BRIEF DESCRIPTION OF THE DRAWINGS

A description is now given, by way of example only, with reference to the accompanying drawings, in which:

FIGS. 1(a) and 1(b) are front and side elevations respectively of a corkscrew;

FIG. 2 shows a further corkscrew;

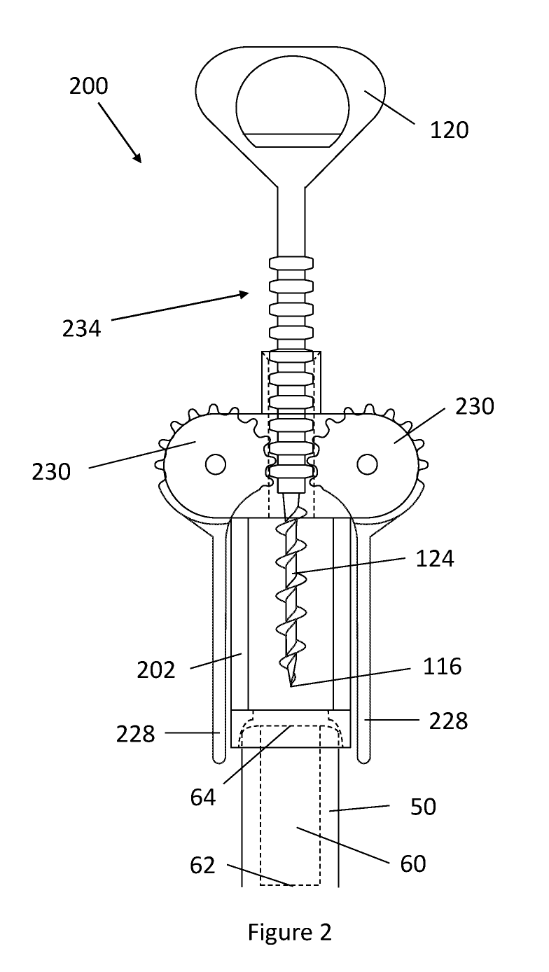

FIG. 3 shows a corkscrew according to the invention;

FIGS. 4(a), 4(b) and 4(c) illustrate the operation of the corkscrew of FIG. 3;

FIGS. 5(a) and 5(b) show an alternative form of part of the corkscrew of FIG. 3; FIGS. 5(c) and 5(d) show an alternative form of another part of the corkscrew of FIG. 3; FIGS. 5(e) and 5(f) show further alternative forms of the part of the corkscrew of FIG. 3 that is shown in FIG. 5(a).

FIG. 6 shows another example of a corkscrew according to the invention;

FIGS. 7(a), 7(b), 7(c), 7(d), 7(e), 7(f) and 7(g) illustrate the operation of the corkscrew of FIG. 6;

FIG. 8 shows a further example of a corkscrew according to the invention;

FIG. 9 shows a still further example of a corkscrew according to the invention;

FIG. 10 shows yet another example of a corkscrew according to the invention;

FIGS. 11(a) and 11(b) show some alternative parts of a corkscrew according to the invention.

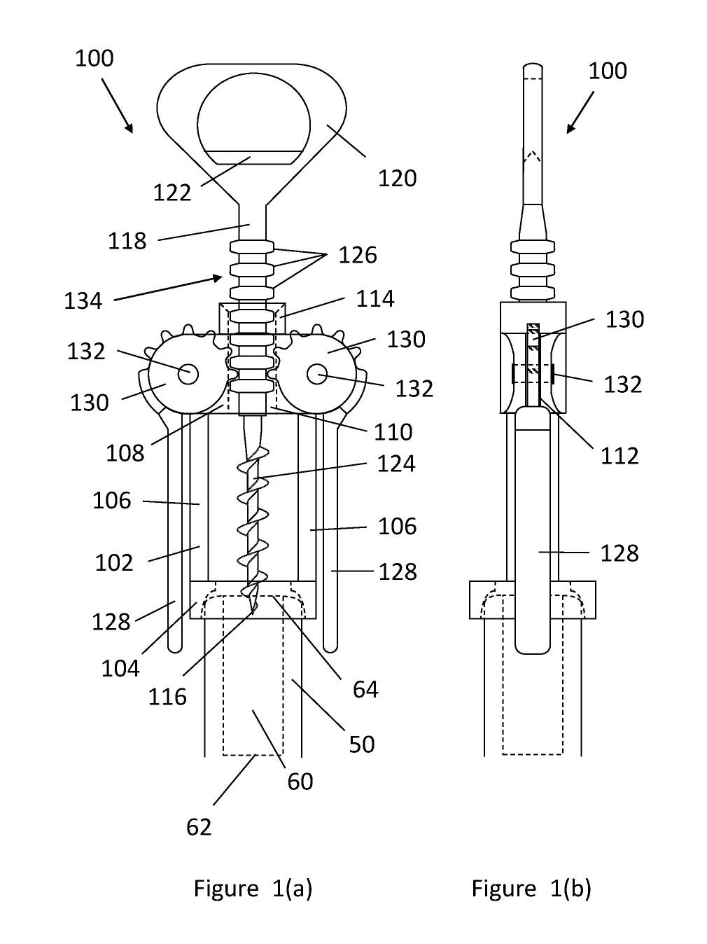

Note that in all drawings which include the frame of a corkscrew, except FIG. 1b, the frame is drawn in outline only, so as to make clearer the depiction of the rack-and-pinion mechanism.

### DETAILED DESCRIPTION

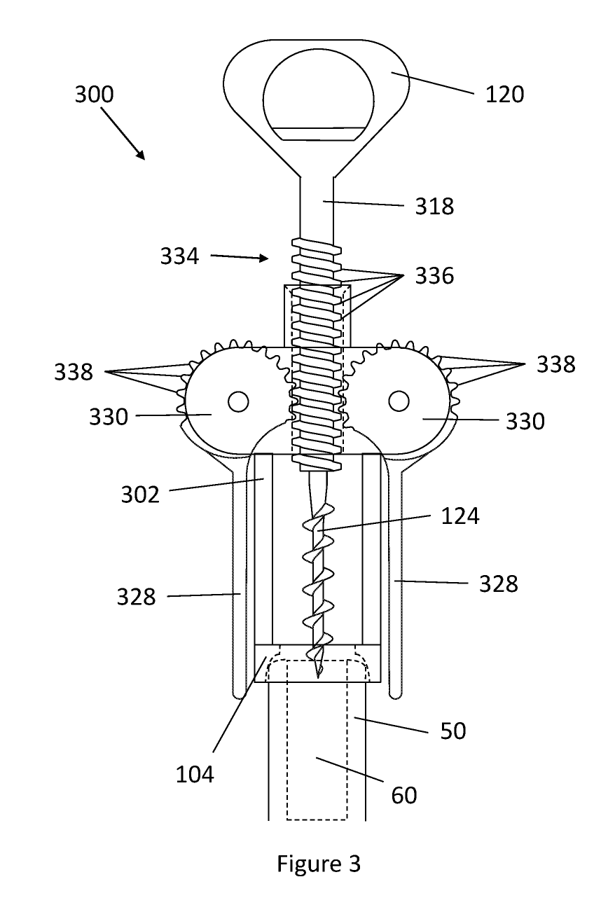

FIG. 3 shows one example of a corkscrew 300 according to the invention.

The corkscrew 300 comprises a threaded bit 124 for engaging a stopper (in this case a cork 60), a shaft 318 supporting the threaded bit 124, and a pair of lever arms 328 connected to the shaft 318 by a rack-and-pinion arrangement. The rack-and-pinion arrangement comprises a pair of pinions 330 operably connected to respective lever arms 328, and a threaded rack 334 comprising a thread 336 extending around the shaft 318. According to the invention, the threaded rack 334 is of opposite handedness to the threaded bit 124. In this embodiment, the thread 336 is a single-start or one-start thread, which winds in a left-handed direction around the shaft 318. The threaded bit 124 in this case is right-handed.

The corkscrew 300 comprises a frame 302 having a locating ring 104 configured to align the bit 124 with the centre of the cork 60. The frame 302 is configured to engage the bottle 50, to hold the pinion 330 of each lever arm 328 in engagement with the threaded rack 334, and to maintain a gap between the locating ring 104 and the axis of the pinions 330.

The shaft 318 comprises a handle 120 to allow the user to push and/or rotate the bit 124 into the cork 60.

The frame 302 supports both pinions 330 at the same axial position relative to an axis of the threaded rack 334. To account for the rack 334 being threaded, the teeth 338 of one pinion 330 are circumferentially staggered relative to those of the other pinion 330, in order that the teeth 338 of both pinions 330 remain fully meshed or engaged with the thread 336 when the lever arms 328 are rotated to the same degree relative to an axis of the threaded rack 334.

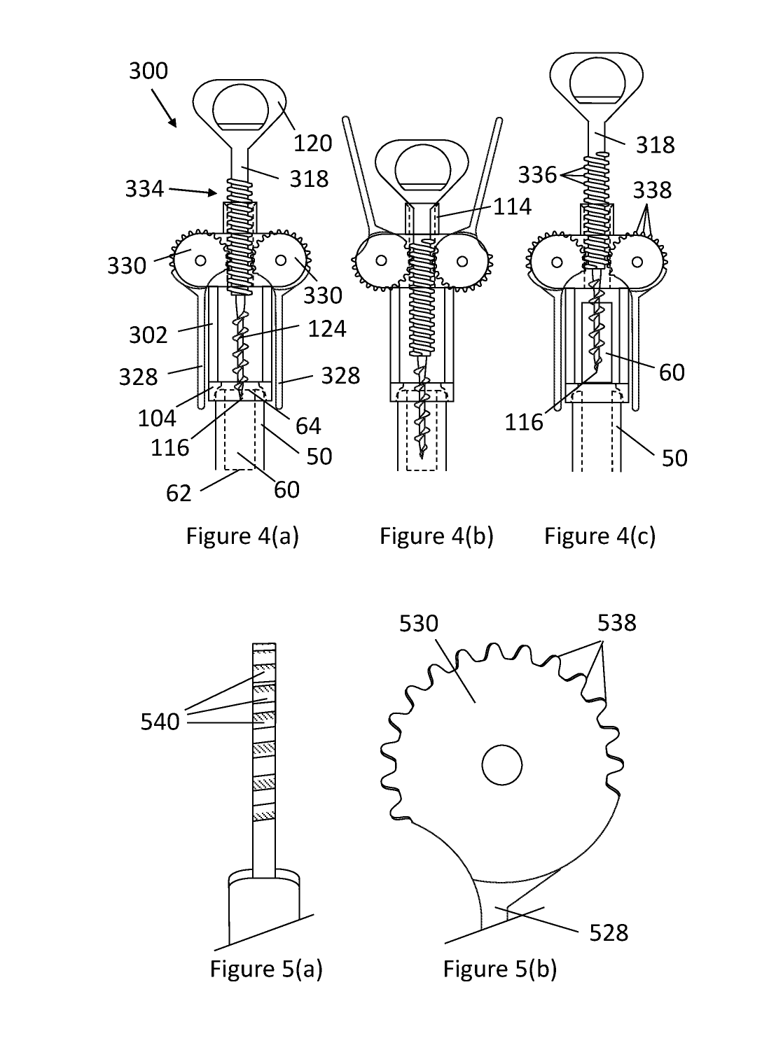

FIGS. 4(a), 4(b) and 4(c) illustrate the operation of the corkscrew 300.

FIG. 4(a) shows the corkscrew 300 in a deployed position, following a deployment operation. FIG. 4(b) shows the corkscrew 300 in a set position, having moved from the deployed position in a setting operation, and FIG. 4(c) shows the corkscrew 300 in a finishing position, having moved from the set position in a removal operation.

In the deployment operation, to reach the deployed position shown in FIG. 4(a), the lever arms 328 are lowered as far as possible, and the corkscrew 300 is positioned such that the locating ring 104 sits on top of the neck of the bottle 50.

With the lever arms 328 held down, the handle 120 is rotated anticlockwise to move the shaft 318 downwardly until the tip 116 pierces the top 64 of the cork 60. The locating ring 104 serves to centre the tip 116 in the cork 60. Particularly for threaded bits of the auger type, this method has the benefits of good mechanical advantage and ease of accurate control. For bits of the worm type, where the tip is usually some distance from the axis of the bit and not aligned with the axis, it may be better to position the tip 116 such that it just touches the top 64 of the cork 60, without piercing it.

In the setting operation, to move from the deployed position shown in FIG. 4(a) to the set position shown in FIG. 4(b), the locating ring 104 is held down on the neck of the bottle 50, and the lever arms 328 released, while the threaded bit 124 is driven into the cork 60 by rotating the handle 120 clockwise. Axial and rotational movement of the handle 120 to drive the bit 124 into the cork 60 is transmitted by the rack-and-pinion arrangement to the lever arms 328, causing the lever arms 328 to rotate upwardly. The rotation of the handle 120 is stopped when the handle 120 reaches the collar stop 114, or earlier if the tip 116 has been driven the desired distance into the cork 60. The bit 124 thereby engages the cork 60, but does not pass through the innermost end 62 of the cork 60.

In the removal operation, to move from the set position shown in FIG. 4(b) to the finishing position shown in FIG. 4(c), the lever arms 328 are actuated by moving them downwardly through their full range of motion, which causes the shaft 318 and thereby the bit 124 to move upwardly. The lead angle of the thread 336 is such that the actuation of the lever arms 328 during the removal operation does not cause substantial rotation of the threaded rack 334. The rotation of the lever arms 328 is instead converted by the rack-and-pinion arrangement to axial movement of the shaft 318.

Any tendency to slippage of the teeth 338 relative to the shaft thread 336, and consequent rotation of the shaft 318, during the removal operation can be minimised by adjusting one or more of a number of controllable variables. Such adjustments may include decreasing the lead angle of the shaft thread 336, either by increasing its diameter or reducing its pitch; reducing the pitch of the threaded bit 124, or increasing its roughness to prevent it from disengaging from the cork 60; and increasing the frictional resistance of the contact between the pinion teeth 338 and the shaft thread 336 by angling and/or throating the pinion teeth 338 to increase the contact area, making the pinion teeth 338 wider, or increasing the roughness of the gear surfaces.

When the threaded rack 334 rotates in a clockwise direction during the setting operation, the thread 336 acts as an inclined plane to amplify the travel of the pinions 330. In particular, the thread 336 amplifies the travel of the pinions 330 by a factor of 1+a/b, where “a” is the pitch (the axial period) of the thread 336 of the threaded rack 334 and “b” is the pitch of the thread of the threaded bit 124. Thus, when the handle 120 is rotated clockwise with the cork 60 engaged by the bit 124, the bit 124 moves into the cork 60 by a distance of b per revolution of the handle, whilst the lever arms 328 move upwardly, with the tips of the teeth 338 moving a distance of a +b per revolution. Since the threaded rack 334 does not substantially rotate during the removal operation, the bit 124 travels upward (relative to the frame 302) during the removal operation more than its downward travel during the setting operation by a factor of 1+a/b. In other words, the amplifying effect of the threaded rack 334 when it rotates during the setting operation shortens the downward travel of the bit 124 compared to its upward travel during the removal operation. This permits a design in which the tip 116 may start from the top 64 of the cork 60, or from a position in which it has pierced the top 64 of the cork 60, and yet be prevented from passing through the innermost end 62 of the cork 60, while allowing the cork 60 to be removed completely from the bottle 50 in one movement of the lever arms 328.

It can be seen from the finishing position shown in FIG. 4(c) that the tip 116 has moved upwards, out of the neck of the bottle 50, from where it was in the deployed position shown in FIG. 4(a), owing to the difference in travel between the setting and removal operations. The tip 116 can be moved into the correct position prior to the next removal by performing the deployment operation, as described above.

In an alternative use of the corkscrew 300, the position of the lever arms 328 can be freely adjusted by rotating the frame 302 around the shaft 318, with the bit 124 having been driven into the cork 60. The lever arms 328 can then be re-raised at will by turning the frame 302 anticlockwise (as seen from above) relative to the shaft 318.

In this embodiment, the corkscrew 300 is arranged such that the length of travel of the bit 124 provided by the rack-and-pinion arrangement is sufficient to provide for a complete removal of the cork 60 in one downward movement of the lever arms 328, that is, the shaft travel is equal to or greater than the cork length.

Amplification of travel is determined by the ratio a/b as discussed. As an example, assuming that only enough travel is required to remove the cork entirely with between 5 and 15 per cent of the length of the cork to spare, and that travel of the tip 116 of the threaded bit 124 during the setting operation is 75 per cent of the length of the cork 60, then a/b would need to be between 105/75−1=0.4 and 115/75−1=0.53. For the one-shot corkscrew 300, any greater ratio a/b would increase travel beyond that range, which would in turn require larger lever arm pinions 330 for a given range of rotation of the lever arms 328, without providing any appreciable benefit.

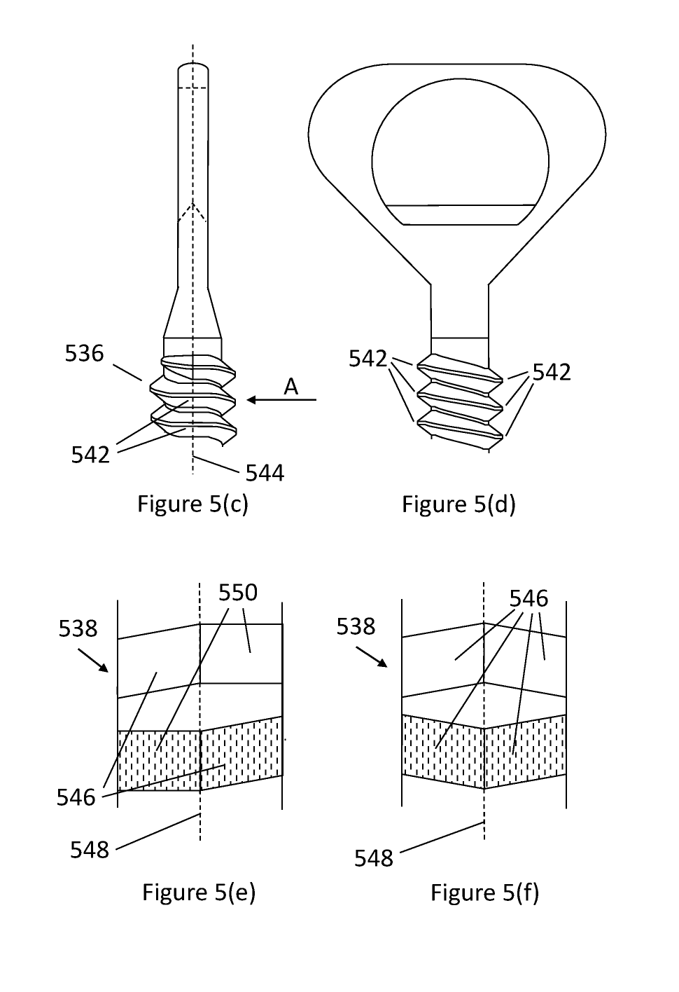

FIGS. 5(a) and 5(b) show an alternative form of lever arm 528. As shown, the lever arm 528 has a pinion 530 whose teeth 538 comprise bearing faces 540 which are angled (set obliquely) relative to the axis of the pinion 530, so as to be aligned with bearing faces of the thread 336. This provides for a better engagement between the pinion 530 and the thread 336.

Helical shapes are difficult to die-cast because they have undercuts. The components of worm drives (worms and helical gears) are normally manufactured by other means for this reason. Finely threaded shapes can be die-cast in a conventional two-part die with a planar parting surface, but considerable force may be needed to extract the cast part from the die, with attendant risk of damaging or distorting the cast part and/or the die. Any shaft with an unmodified helical thread that would be suitable for use in the invention is likely not to have a die-extractable surface (as earlier defined). Alternatively, more complex die set-ups may be used, for example using two side pulls or loose inserts, but these methods may make production slower and more costly.

However, it is feasible to produce a serviceable threaded shaft whilst avoiding undercuts by using a suitable tapered thread ridge profile and varying the lead angle. FIGS. 5(c) and 5(d) show an alternative form of shaft thread 536 designed to facilitate production by die-casting, by avoiding undercuts. In FIG. 5(c), the combination of “flat” regions 542, where the helix lead angle is zero as the thread crosses the die parting plane 544, and the tapered profile of the ridge that forms the thread 536 allows a shape which is free from undercuts when viewed in the direction of the arrow A, normal to the die parting plane 544, as shown in FIG. 5(d). Note that very small undercuts may in practice be tolerated without impairing the die-extractability of the cast part. For example, a threaded shaft comprising flat regions of very low lead angle (say less than 1 degree) would have small undercuts but might still be extractable from the die without excessive force.

Common worm thread ridge profiles such as trapezoidal, rounded trapezoidal and sinusoidal may be used. By way of example, a shaft whose thread has a sinusoidal ridge profile, flat regions extending 10 degrees around the shaft axis on each side of the parting plane, and transition regions of 10 degrees between these flat regions and the remaining thread, is free of undercuts provided that the ratio of the outer diameter of the threaded shaft to the height of the thread ridge is greater than about 4.5 to 1.

The flat regions 542 also provide an operational advantage. If the flat regions are in contact with the lever arm pinions as the cork is extracted, any tendency for the shaft thread 536 to rotate the corkscrew bit in a way that might cause it to disengage is eliminated. Moreover, the frame can be rotated freely relative to the shaft thread, allowing the user to align the pinions with the flat regions once the corkscrew bit is fully engaged.

FIGS. 5(e) and 5(f) show alternative forms of a lever arm pinion tooth, viewed along a line perpendicular to the pinion axis, which are also shaped so as to avoid undercuts. The tooth 538 in FIG. 5(e) has faces 546 that are angled as far as the pinion mid-plane 548 to provide improved alignment with a left-handed threaded rack. In addition, the straight faces 550 provide bearing surfaces that are aligned with the flat regions 542 of a modified helical thread of the type depicted in FIGS. 5(c) and 5(d), so this tooth design is particularly suitable for use with a threaded rack of that type.

The tooth 538 in FIG. 5(f) has four angled faces 546 having mirror symmetry across the pinion mid-plane 548. This form is suitable for use in embodiments in which two identical lever arms face in the same direction, and can be used with a right-handed or left-handed threaded rack. Variants of the tooth shapes shown in FIGS. 5(e) and 5(f) that comprise rounded edges or surfaces may also be used, provided care is taken to avoid introducing new undercuts.

In practice, die-cast lever arms are commonly used in wing corkscrews, and often have rounded pinion teeth with convex bearing surfaces. Such lever arm pinions should generally operate satisfactorily with a helical threaded rack, though the limited contact area with the threaded rack may increase the risk of slippage.

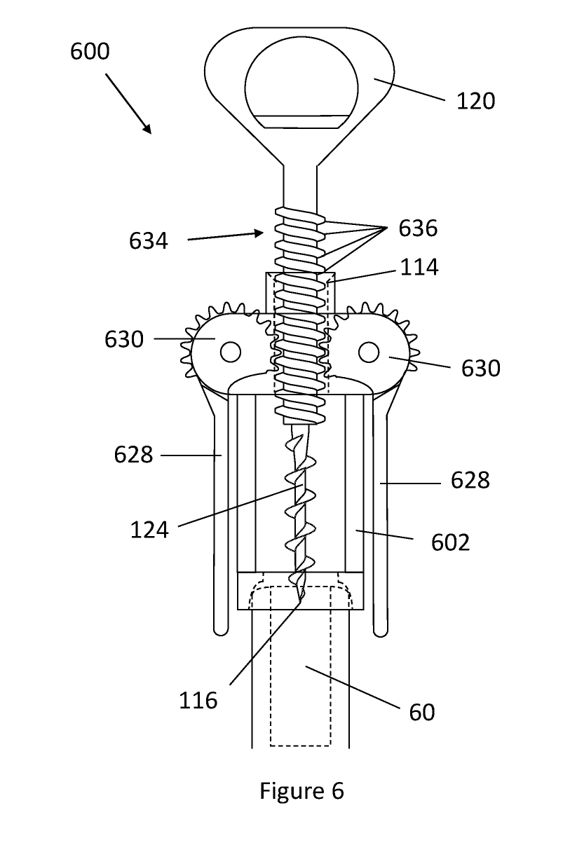

FIG. 6 shows another example of a corkscrew 600 according to the invention.

The corkscrew 600 is a compact version which retains all of the advantages of the device of FIG. 3 except for complete one-shot removal of the cork 60, owing to the corkscrew 600 having a similar size and proportions to those of the device depicted in FIG. 1. In other words, the compact pinions 630 and threaded rack 634 provide a length of travel of the threaded bit 124 which is less than the length of a standard cork 60.

The preferred method of operation differs from that of the device in FIG. 3 in that the bit 124 is driven into the cork 60 until the lever arms 628 are partially raised. The lever arms 628 are then lowered by rotating the frame 602 clockwise relative to the handle 120, and then re-raised by screwing the bit 124 into the cork 60 until the handle 120 reaches the collar stop 114. The cork 60 is then drawn out as far as possible by fully lowering the lever arms 628. The lever arms 628 are partially re-raised by rotating the frame 602 anticlockwise, and a second lowering of the lever arms 628 withdraws the cork 60 entirely. So compared with the operation of the one-shot device of FIG. 3, the setting and removal operations are each interrupted by a step involving rotation of the frame 602. These extra steps are rapid and convenient. The cork 60 can still be extracted completely, with mechanical advantage throughout, the accurate and simple deployment operation for initial location of the corkscrew tip 116 is unaffected, and there is no need to screw the tip 116 of the bit 124 into the cork 60 beyond the designed stop position.

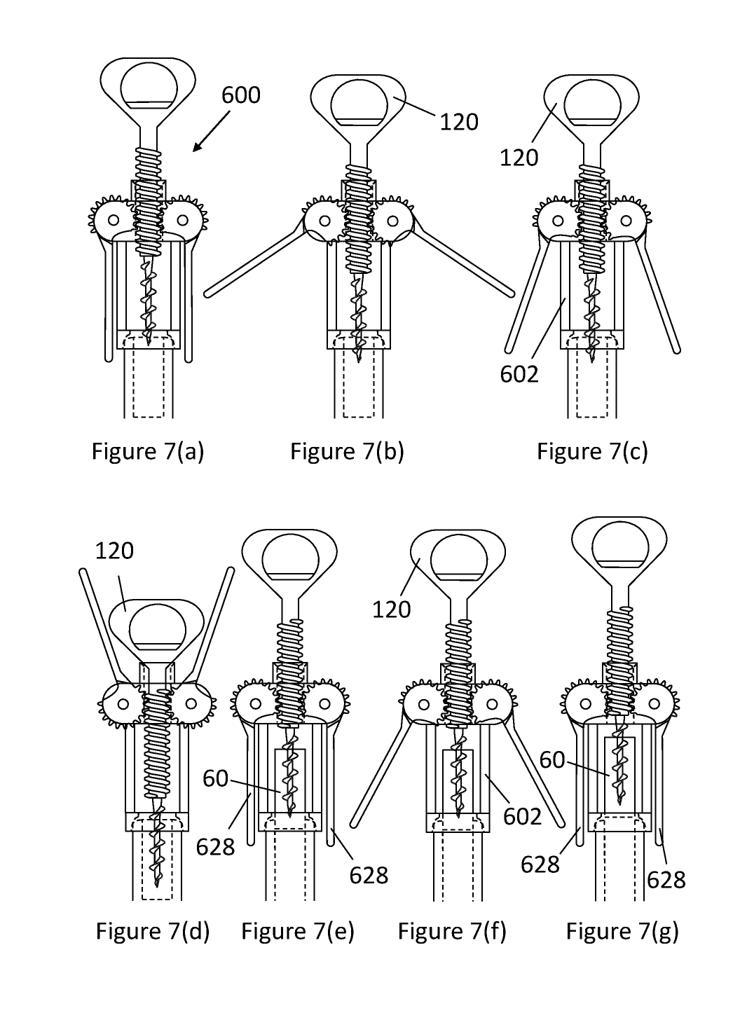

FIGS. 7(a) to 7(g) illustrate this operation of the compact corkscrew 600 in more detail.

FIG. 7(a) shows the corkscrew 600 in a deployed position, following a deployment operation identical to that used for the one-shot device of FIG. 3. FIG. 7(b) shows the corkscrew 600 in a partially set position, reached from the position in FIG. 7(a) after a single clockwise revolution of the handle 120. FIG. 7(c) shows the corkscrew 600 in an intermediate position, arrived at from the position in FIG. 7(b) by two clockwise revolutions of the frame 602 relative to the handle 120. FIG. 7(d) shows the corkscrew 600 in the fully set position, reached from the position in FIG. 7(c) by 2.5 more clockwise revolutions of the handle 120. FIG. 7(e) shows the corkscrew 600 after actuation of the lever arms 628 to lower them fully has largely withdrawn the cork 60. FIG. 7(f) shows the corkscrew 600 in a partially reset position, reached from the position in FIG. 7(e) after 1.5 anticlockwise revolutions of the frame 602 relative to the handle 120. Finally, FIG. 7(g) shows the corkscrew 600 in finishing position, with the cork 60 fully extracted, reached from the position in FIG. 7(f) by a second actuation of the lever arms 628.

In compact devices such as the corkscrew 600, a higher ratio a/b is more advantageous than with one-shot devices, because a higher ratio provides more efficient raising and lowering of the lever arms 628 as the frame 602 is rotated relative to the handle 120 with the bit 124 engaged, as part of the preferred operating sequence described for the corkscrew 600. Thus embodiments with a/b ranging from 0.4 to 0.8 all perform efficiently. However, increasing the pitch (a) of the shaft thread 636 does increase the risk of gear slippage as the cork 60 is being removed. This tendency may need to be counteracted by adjusting other controllable variables.

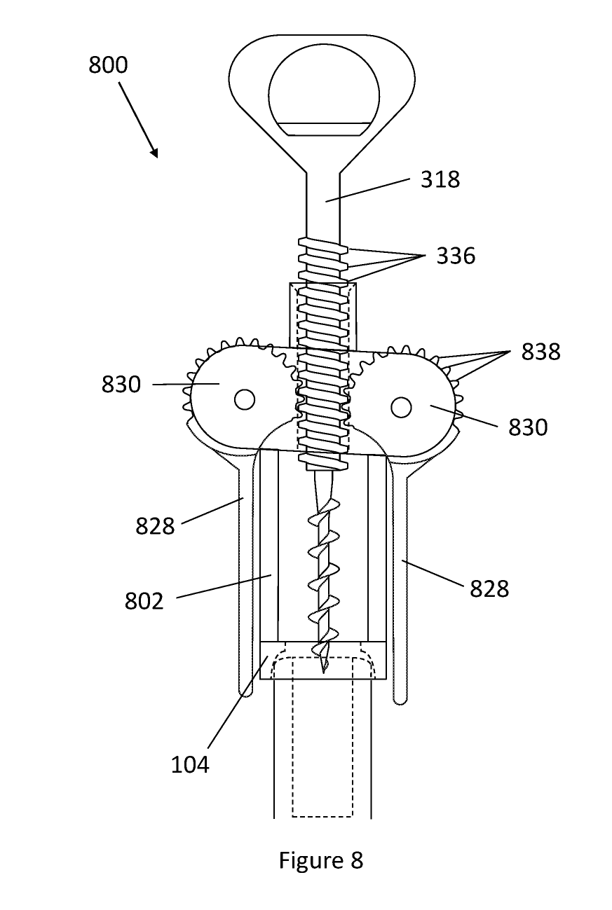

FIG. 8 shows a further example of a corkscrew 800 according to the invention.

The corkscrew 800 differs from the corkscrew 300 in that the lever arms 828 have an identical shape to one another, which means that the teeth 838 of one pinion 830 are at the same circumferential positions as those of the other pinion 830.

In order for the teeth 838 of each pinion 830 to be arranged so as to engage the thread 336, the axial positions of the pinions 830 relative to the shaft 318 are staggered by the frame 802. More particularly, the pinions 830 are set at heights above the locating ring 104 which differ by half of the pitch of the thread 336. Relative to the first lever arm 828, the second lever arm 828 is rotated 180 degrees around the axis of the shaft 318 and displaced by half of the pitch of the thread 336. This places no new constraint on the design of the lever arm 828, and also works with pinion 830 having angled teeth, as shown in FIG. 5(a) or 5(e).

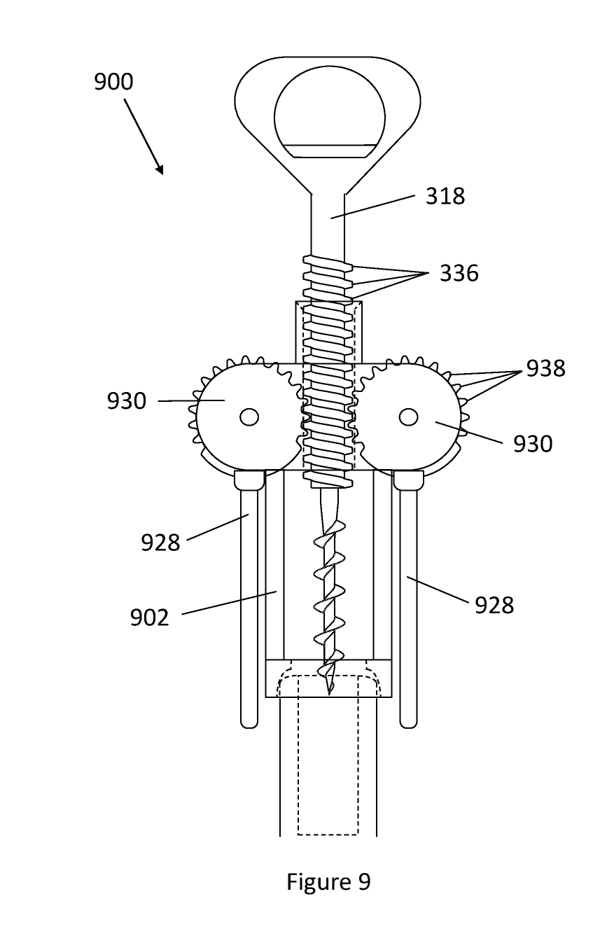

FIG. 9 shows a still further example of a corkscrew 900 according to the invention.

The corkscrew 900 differs from the corkscrew 300 in that the lever arms 928 have an identical shape to one another. Since both lever arms 928 have an identical shape, the teeth 938 of one pinion 930 are at the same circumferential positions as those of the other pinion 930. Moreover, each pinion 930 is at the same axial position relative to the shaft 318.

In order for the teeth 938 of each pinion 930 to be arranged so as to engage the thread 336, the teeth 938 on each pinion 930 are spaced by a number of degrees equal to or about 360/n, where n is an odd number greater than one. This arranges the teeth 938 such that each tooth is located diametrically opposite a gap between the teeth on the other side of the pinion 930, or where there would be a gap if the teeth extended around the complete circumference of the pinion 930. In other words, the tooth spacing would give an odd number of equally spaced teeth 938 in a full circumference of the pinion 930. The lever arms 928 are attached to the frame 902 so as to face in the same direction, rather than towards each other, such that the inwardly-facing teeth 938 of the two pinions 930 are always staggered with respect to one another.

To preserve a generally symmetrical overall appearance, the lever arms 928 need to be straight and aligned with the axis of the pinion 930, rather than being offset. Symmetrically angled pinion teeth of the type illustrated in FIG. 5(f) may be used in this embodiment.

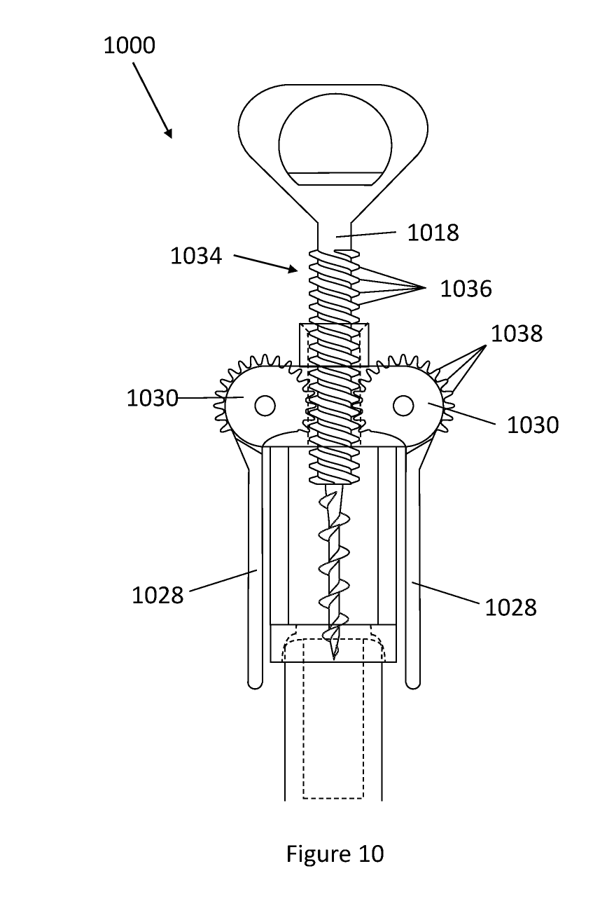

FIG. 10 shows yet another example of a corkscrew 1000 according to the invention.

The corkscrew 1000 is a compact version which differs from the corkscrew 600 in that the threaded rack 1034 comprises a two-start thread 1036, which in this example is a double helix.

The two-start thread 1036 allows the lever arms 1028 to have an identical shape to one another, it allows each pinion 1030 to be at the same axial position relative to the shaft 1018, and it allows the teeth 1038 of each pinion 1030 to be at the same circumferential positions. Thus, the corkscrew 1000 provides freedom of design of the lever arms 1028, including angled teeth on the pinions 1030, as shown in FIG. 5(a) or 5(e).

As with the corkscrew 600 shown in FIG. 6, the compact pinions 1030 and threaded rack 1034 of the corkscrew 1000 provide a length of travel of the threaded bit 124 which is less than the length of a standard cork 60. The operation of the corkscrew 1000 is essentially the same as that of the corkscrew 600.

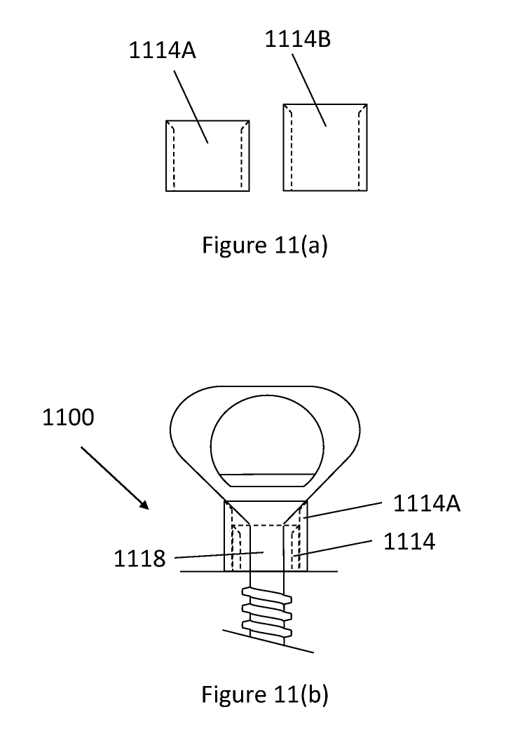

FIGS. 11(a) and 11(b) show some alternative parts of a corkscrew according to the invention.

More particularly, FIG. 11(a) shows a pair of interchangeable collar stop extensions 1114A and 1114B. FIG. 11(b) shows the collar stop extension 1114A fitted to a corkscrew 1100. Each collar stop extension 1114A and 11148 is a snugly-fitting tubular extension configured to sit over a shorter integral collar stop 1114, for example using a friction fit or a threaded fit. In one example, the extension 1114A extends the integral collar stop 1114 by about 10 percent of the length of the cork, and the extension 11148 extends the integral collar stop 1114 by about 20 percent of the length of the cork. This may be useful in connection with markets in which more than one standard cork size is in use, for example the US. The collar stop extensions may be attached or replaced by first unscrewing the shaft 1118 from the frame (not shown in FIG. 11(b)).

Any of the embodiments described in this application may incorporate the arrangement shown in FIGS. 11(a) and 11(b).

Alternative embodiments comprise extendable frame struts, which in one example are telescopic, being securable by locking pegs or lock nuts.

Another embodiment comprises stops for the lever arms, which in one example take the form of protuberances on an upper edge of the crossbar to prevent over-rotation of the lever arms, which in the embodiments disclosed herein are decoupled from the shaft.

A further variant comprises a handle which is connected or connectable to the lever arms, the frame, or the locating ring to facilitate spinning the frame around the shaft.

Yet another embodiment comprises a shaft removal stop configured to prevent the shaft from being removable. In one example, the shaft removal stop takes the form of an annular rib at the lower end of the shaft.

A still further embodiment comprises a rotation lock for the shaft, which in one example comprises a sliding bolt mounted parallel to the shaft on the frame, which can be slid into a position to block anticlockwise movement of the handle.

Thus the invention combines the desired advantages of complete one-stroke removal of the cork, accurate centering of the bit, prevention of piercing the lower end of the cork, and simplicity of manufacture.

The invention has the added advantage that, at any stage in the process of extracting the cork, the position of the lever arms can readily be adjusted without the need to adjust the position of the bit in the cork. This property is particularly important for the efficient operation of the compact embodiments of the invention, allowing the height of the arms to be reset at will in the course of both the setting and removal processes, and the cork to be removed with full control and mechanical advantage throughout the deployment and removal operations. In all embodiments it also allows the user to deal easily with non-standard corks or inadvertent variations in the depth of the corkscrew bit in the cork.

A second added advantage is that the handle, shaft and bit can be removed entirely from the frame. This feature creates the potential readily to interchange handles and bits, for example to use with longer or shorter corks or to replace a damaged bit, and facilitates the use of interchangeable collar stop extensions. The separate handle may also serve as a more convenient crown seal opener than the full assembly. Having a removable handle, shaft and bit also simplifies initial assembly, since this sub-assembly can simply be screwed into the frame as a final step, rather than being installed simultaneously with the lever arms. In addition, the lever arms can be installed independently of each other.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A corkscrew comprising a threaded bit for engaging a stopper, a shaft supporting the threaded bit, and one or more lever arms connected to the shaft by a rack-and-pinion arrangement, the rack-and-pinion arrangement comprising one or more pinions operably connected to respective lever arms and a threaded rack comprising a thread extending around the shaft, wherein the threaded rack is of opposite handedness to the threaded bit.

2. The corkscrew of claim 1, comprising a plurality of lever arms which have an identical shape to one another.

3. The corkscrew of claim 1, comprising a plurality of lever arms and a frame which supports each pinion at the same axial position as the other pinions relative to an axis of the threaded rack, wherein, to ensure that teeth of each pinion are arranged to follow the thread when each lever arm is at the same degree of rotation relative to the threaded rack, the teeth of each pinion are circumferentially staggered relative to those of the other pinions.

4. The corkscrew of claim 2, wherein teeth of each pinion are at the same circumferential positions as those of the other pinions, and wherein, to ensure that the teeth of each pinion are arranged to follow the thread when each lever arm is at the same degree of rotation relative to the threaded rack, the corkscrew supports the pinions at staggered axial positions relative to an axis of the threaded rack.

5. The corkscrew of claim 2, wherein teeth of each pinion are at the same circumferential positions as those of the other pinions, wherein the corkscrew supports each pinion at the same axial position as the other pinions relative to an axis of the threaded rack, and wherein, to ensure that the teeth of each pinion are arranged to follow the thread when each lever arm is at the same degree of rotation relative to the threaded rack, the teeth on each pinion are spaced by a number of degrees equal to or about 360/n, where n is an odd number greater than one.

6. The corkscrew of claim 2, wherein teeth of each pinion are at the same circumferential positions as those of the other pinions, wherein the corkscrew supports each pinion at the same axial position relative to an axis of the threaded rack as the other pinions, and wherein, to ensure that the teeth of each pinion are arranged to follow the thread when each lever arm is at the same degree of rotation relative to the threaded rack, the thread is a multiple-start thread, and pinions are positioned around an axis of the threaded rack at angular intervals that are integer multiples of 360/m degrees, where m is the number of starts of the thread.

7. The corkscrew of any of claims 1-6, wherein the threaded rack is shaped so as to have a die-extractable surface.

8. The corkscrew of claim 7, wherein the threaded rack comprises diametrically-opposite regions in which a portion of the thread having a reduced lead angle cooperates with a tapered thread profile to define the die-extractable surface.

9. (canceled)
